(19) United States
(12) Patent Application Publication
(10) Pub. No.: US 2026/0353252 A1
(43) Pub. Date: Nov. 5, 2026

(54) WIRELESS NODE ROLE DETERMINATION BASED ON LOCATION OR MOVEMENT

(71) Applicant: Cisco Technology, Inc., San Jose, CA (US)

(72) Inventors: Domenico Ficara, Essertines-sur-Yverdon (CH); Amine Choukir, Ecublens (CH); Vincent Cuissard, Eteaux (FR); Anirban Karmakar, Ecublens (CH)

(73) Assignee: Cisco Technology, Inc., San Jose, CA (US)

(21) Appl. No.: 19/194,420

(22) Filed: Apr. 30, 2025

(51) Int. Cl. H04W 48/08; H04L 41/0893; H04W 48/18; H04W 84/18

(52) U.S. Cl. CPC H04W 48/08; H04L 41/0893; H04W 48/18; H04W 84/18

(57) ABSTRACT

In one embodiment, a device makes a first determination as to whether it has wired network connectivity. The device also makes a second determination as to whether it is moving over time. The device sends an advertisement of capabilities of the device based on the first determination and on the second determination. The device joins a wireless network with a role assigned to the device based on the capabilities of the device indicated in the advertisement, wherein the role is either a fixed node role or a mobile node role.

### TECHNICAL FIELD

The present disclosure relates generally to wireless networks, and, more particularly, to wireless node role determination based on location or movement.

### BACKGROUND

Cellular network coverage has made Internet connectivity increasingly ubiquitous. This has led to an ever-increasing demand for bandwidth, to accommodate traffic such as multimedia content and communications (e.g., bandwidth-intensive high definition video streaming or real time video calls, etc.). For instance, passengers of public transportation now expect on-board, high-speed connectivity, which implies a reliable wireless ground-to-vehicle communication. Accordingly, wireless mesh networks are now being deployed to provide connectivity to such fast-moving mobile systems.

Today, configuring a backhaul mesh network deployment is a manual task, leading to potential misconfigurations. Indeed, large-scale deployments that span large physical areas often require technicians to manually install and configure each device. Further, a one-size-fits-all approach to device configuration is not possible, given the dynamic nature of the network and how the different devices interact with one another over time.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example of a mobile system communicating wirelessly;

FIG. 4 illustrates an example of wireless devices advertising their capabilities;

FIG. 5 illustrates an example of wireless nodes forming network clusters based on their roles; and

FIG. 6 illustrates an example simplified procedure for wireless node role determination based on location or movement.

### DESCRIPTION OF EXAMPLE EMBODIMENTS

### Overview

According to one or more embodiments of the disclosure, a device makes a first determination as to whether it has wired network connectivity. The device also makes a second determination as to whether it is moving over time. The device sends an advertisement of capabilities of the device based on the first determination and on the second determination. The device joins a wireless network with a role assigned to the device based on the capabilities of the device indicated in the advertisement, wherein the role is either a fixed node role or a mobile node role.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P 1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

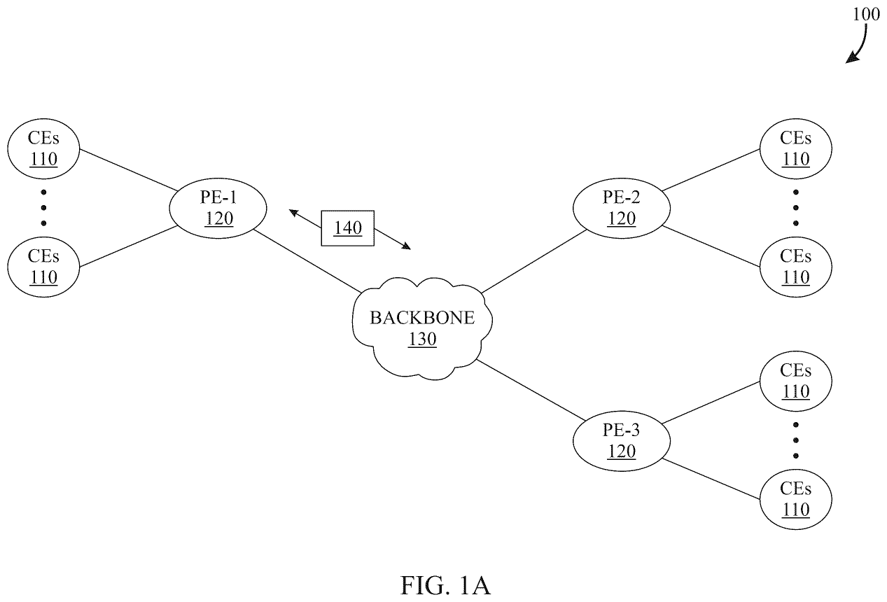

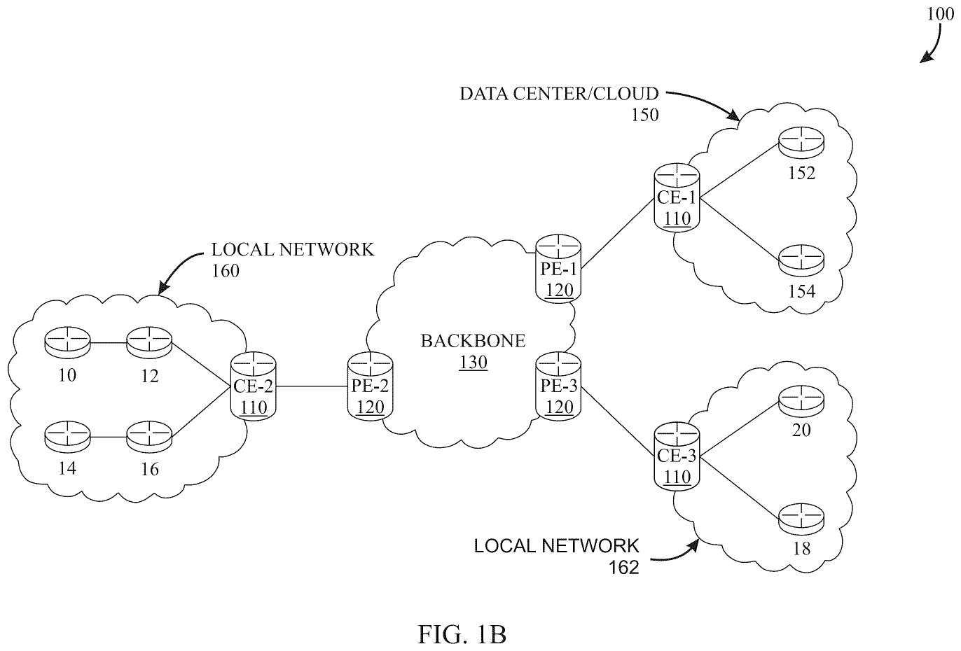

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B 1, B 2 or B 3) but with more than one CE router (e.g., a first CE router connected to one link while a second CE router is connected to the other link), and potentially a backup link (e.g., a wireless 3G/4G/5G/LTE backup link). For example, a particular customer site may include a first CE router connected to PE-2 and a second CE router connected to PE-3.

FIG. 1B illustrates an example of computer network 100 in greater detail, according to various embodiments. As shown, network backbone 130 may provide connectivity between devices located in different geographical areas and/or different types of local networks. For example, computer network 100 may comprise local networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

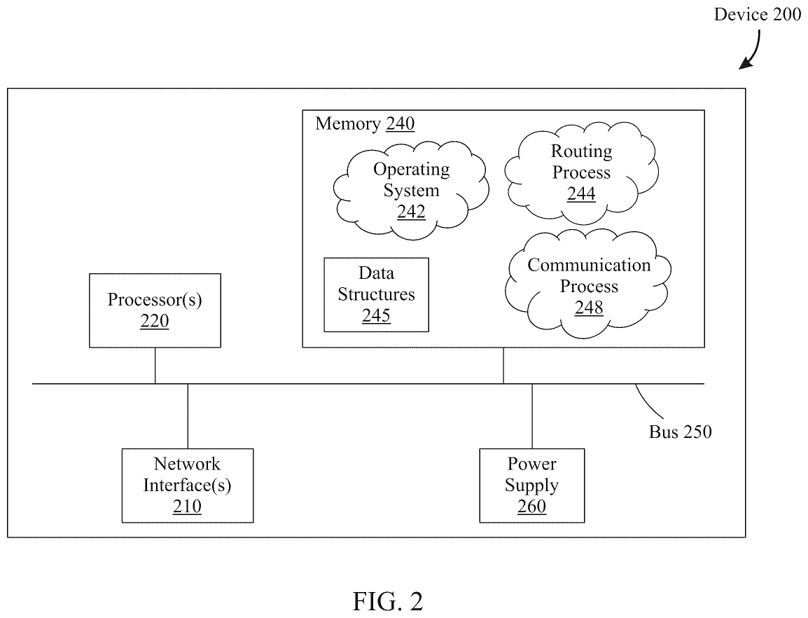

FIG. 2 is a schematic block diagram of an example node/device 200 (e.g., an apparatus) that may be used with one or more implementations described herein, e.g., as any of the devices shown in FIGS. 1A-1B above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s). The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, a Global Positioning System (GPS) receiver, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processors and/or services may comprise a routing process 244 and/or a communication process 248.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Routing process 244 includes instructions executable by the one or more processors 220 to perform functions provided by one or more routing protocols, such as proactive or reactive routing protocols as will be understood by those skilled in the art. These functions may, on capable devices, be configured to manage a routing/forwarding table (a data structure 245) including, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), 6LoWPAN Ad Hoc On-Demand Distance Vector Routing (LOAD), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

In general, communication process 248 includes instructions executable by the one or more processors 220 to perform functions related to a mobile system roaming from one wireless access point to another. To this end, communication process 248 may operate in conjunction with routing process 244, in some instances, to establish and maintain one or more LSPs between a mobile system and the backend infrastructure. An example protocol that uses label-switched paths is the Multiprotocol Label Switching (MPLS) protocol. In general, MPLS operates by appending an MPLS header to a packet that includes a label ‘stack.’ The label(s) in the stack are inserted by a label edge router (LER) based on the forwarding equivalence class (FEC) of the packet. Paths are also managed via the Label Distribution Protocol (LDP) or Resource Reservation Protocol-Traffic Engineering (RSVP-TE). Another protocol that communication process 248 may utilize is the Control and Provisioning of Wireless Access Points (CAPWAP) protocol.

In various implementations, as detailed further below, communication process 248 may include computer executable instructions that, when executed by the one or more processors 220, cause device 200 to perform the techniques described herein. To do so, in some implementations, communication process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, communication process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that communication process 248 can use include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, communication process 248 may also use one or more generative AI/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs) and other foundation models, diffusion models, transformer models, and the like.

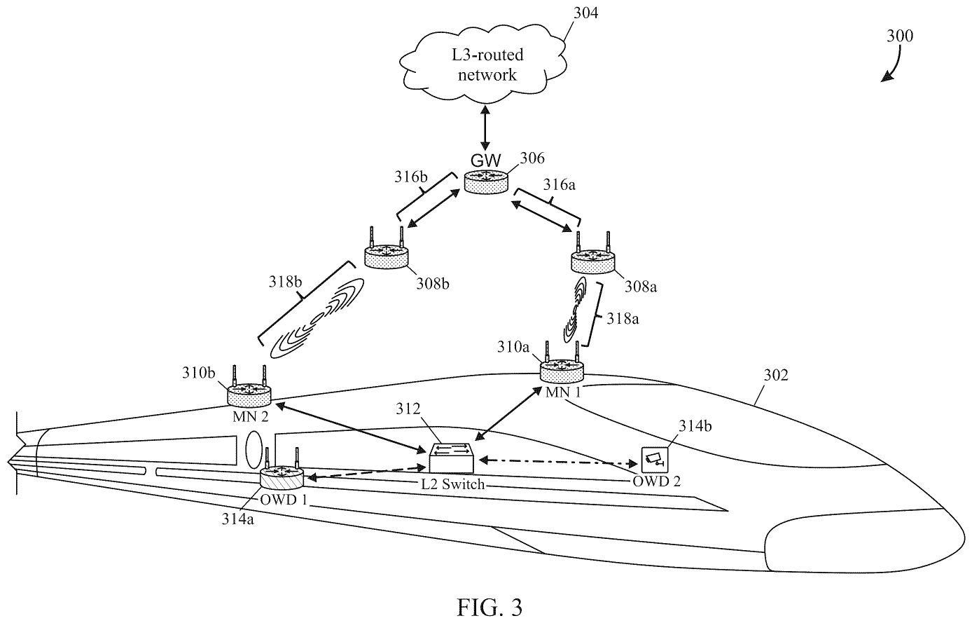

FIG. 3 illustrates an example 300 of a mobile system communicating wirelessly, according to various embodiments. As shown, the mobile system 302 may generally take the form of any mobile object or set of objects equipped with its own internal network and configured to communicate wirelessly with a backhauling system during motion. For instance, mobile system 302 may take the form of a train, bus, airplane or other flying vehicle, ferry, automobile, mine cart, crane, truck, another form of vehicle that may be used for transportation or shipping, a vehicle that may be found in a worksite, mining location, industrial site, factory, etc., a robot, or the like. In further cases, mobile system 302 may be a fully-autonomous, or partially-autonomous, vehicle or other system that moves with little or no direct human control.

Onboard the mobile system 302 may be various networking devices that support the mobile domain of mobile system 302. In some embodiments, as shown, there may be a Layer-2 (L2) switch 312 onboard the mobile system 302 that is connected to one or more onboard devices 314 within the mobile domain of mobile system 302. For instance, onboard device 314a may take the form of an onboard Wi-Fi access point that provides connectivity to any number of user devices (e.g., mobile phones, computers, etc.) of passengers being transported by mobile system 302. Conversely, onboard device 314b may take the form of a security camera that is also connected to L2 switch 312. In various embodiments, some or all of the one or more onboard devices 314 may be onboard wired devices (OWDs), meaning that they communicate with L2 switch 312 via wired connections, such as an Ethernet network or the like.

According to various embodiments, the mobile domain of mobile system 302 may also include mobile nodes 310, denoted “MN” in the Figures for simplicity. For instance, as shown, mobile system 302 may include a first mobile node, mobile node 310a, and a second mobile node, mobile node 310b. Each of mobile nodes 310 may generally include: 1.) a wireless interface to exchange data with wireless access points of the backhaul network and 2.) a local interface to exchange data with the local network of mobile system 302. For instance, mobile node 310a and mobile node 310b may each have a wired connection to L2 switch 312. Of course, in some implementations, mobile system 302 may only include a single mobile node, although two or more are preferable to ensure wireless connectivity during movement of mobile system 302.

As would be appreciated, mobile node 310a and mobile node 310b may be located on mobile system 302 at a distance from one another, so as to provide spatial diversity to the potential wireless connection points utilized by mobile system 302. For example, mobile node 310a may be located near the front of mobile system 302 (e.g., the head-end of a train), while mobile node 310b may be located farther towards the rear of mobile system 302 than that of mobile node 310a. Thus, even if a particular one of mobile nodes 310 does not have a reliable wireless connection to the backhaul system, another of mobile nodes 310 of mobile system 302 may (e.g., if the train is going around a curve in the track, etc.). In some instances, mobile nodes 310 may also offer frequency diversity, as well, such as by operating on different frequencies, at least part of the time. As a result, even if one frequency is experiencing interference, the other frequency could be used to form a wireless connection between mobile system 302 and the backhaul system.

Located along the path of travel of mobile system 302 (e.g., a railroad track, a road, a waterway, a runway, etc.) may be any number of wireless base stations/access points 308. For instance, as shown, there may be trackside access points 308a-308b shown. Note that while these wireless access points are referred to herein as ‘trackside,’ their locations can be varied depending on the deployment scenario (e.g., roadside, etc.).

During operation, access points 308a-308b may form wireless connections with mobile node 310a and/or mobile node 310b, to provide wireless connectivity to mobile system 302 as it travels. To this end, each of access points 308 may include at least 1.) a wireless interface to communicate with a mobile node from mobile nodes 310 and 2.) an interface to communicate with a gateway 306, denoted “GW” for simplicity. Typically, the connections between access points 308a-308b and gateway 306 are wired connections that use a suitable wired communication protocol, such as Ethernet.

Gateway 306 represents the other end of the backhauling system and provides Layer-3 (L3) routing functions. To do so, gateway 306 may include at least one interface connected to L3-routed network 304, as well as any number of interfaces to communicate with access points 308. For instance, L3-routed network 304 may take the form of the Internet, in many instances, although the techniques herein may be extended to any number of different types of external networks, as desired.

Traditionally, a backhaul system supporting mobile domains/systems relies on the use of multiple tunnels, to convey traffic between the L3 gateway and the mobile domain/system. For instance, as shown, assume that mobile node 310a has formed a wireless connection 318a with access point 308a. Such a connection may be formed using a suitable transmission protocol, such as the Prodigy protocol by Fluidmesh (now Cisco Systems) or another wireless protocol that supports extremely fast handoffs. Consequently, mobile node 310a may establish a first tunnel over wireless connection 318a. gateway 306 and access point 308a may form a second tunnel via their connection 316a, likewise. Thus, when access point 308a sends traffic that it receives from mobile node 310a towards gateway 306, it may encapsulate the traffic and tunneled via the first tunnel, which access point 308a then encapsulates for transport via the second tunnel to gateway 306. A similar approach may be taken with respect to wireless connection 318b between mobile node 310b and access point 308b, as well as connection 316b between access point 308b and gateway 306.

In alternative embodiments, a single L2 tunnel may be established between each access point 308 and gateway 306. This tunnel will carry L2 traffic between gateway 306 and the mobile node from mobile nodes 310 to which the access point is connected. For instance, a first L2 tunnel may be formed between gateway 306 and access point 308a over which traffic conveyed between access point 308a and mobile node 310a may be transported, assuming that wireless connection 318a exists. Similarly, another gateway 306 and access point 308b may form a second L2 tunnel over which traffic conveyed between access point 308b and mobile node 310b may be transported, assuming that wireless connection 318a exists.

Typically, only a single wireless link is active at any given time between a mobile system, such as mobile system 302, and any given access point from among access points 308. For instance, assume that mobile node 310a is wirelessly connected to access point 308a. In such a case, any other of mobile nodes 310 on mobile system 302 (e.g., mobile node 310b, etc.) may be in an idle state at that time. In other words, one of the mobile nodes (e.g., mobile node 310a) may be designated as the primary, while the other is designated as the secondary (e.g., mobile node 310b) and remains idle. As mobile system 302 roams, the primary node may begin passing its traffic to the secondary node, to begin leveraging its own connection to the fixed infrastructure. In turn, the roles of the two nodes may be switched, thereby making mobile node 310a the secondary node and mobile node 310b the primary node.

As noted above, wireless mesh networks are now being deployed to provide connectivity to such fast-moving mobile systems. Today, though, configuring a backhaul mesh network deployment is a manual task, leading to potential misconfigurations. Indeed, large-scale deployments that span large physical areas often require technicians to manually install and configure each device. Further, a one-size-fits-all approach to device configuration is not possible, given the dynamic nature of the network and how the different devices interact with one another over time.

### Wireless Node Role Determination Based on Location or Movement

The techniques herein simplify the adoption and configuration of wireless nodes in an ultra-reliable wireless network by automating their role assignments.

Illustratively, the techniques described herein may be performed by hardware, software, and/or firmware, such as in accordance with the communication process 248, which may include computer executable instructions executed by the one or more processors 220 (or independent processor of the one or more communication interfaces 210) to perform functions relating to the techniques described herein, potentially in conjunction with routing process 244.

Specifically, in various embodiments, a device makes a first determination as to whether it has wired network connectivity. The device also makes a second determination as to whether it is moving over time. The device sends an advertisement of capabilities of the device based on the first determination and on the second determination. The device joins a wireless network with a role assigned to the device based on the capabilities of the device indicated in the advertisement, wherein the role is either a fixed node role or a mobile node role.

Operationally, the techniques herein first stipulate that nodes can have just a few roles: mobile vs. fixed and mesh-end vs mesh-node. Each node/device performs an automatic role determination process, such as at bootup, by going through the following phases: 1.) a device property discovery phase in which the device determines its capabilities and 2.) a role determination phase in which the role of the device in the network is assigned based on its capabilities.

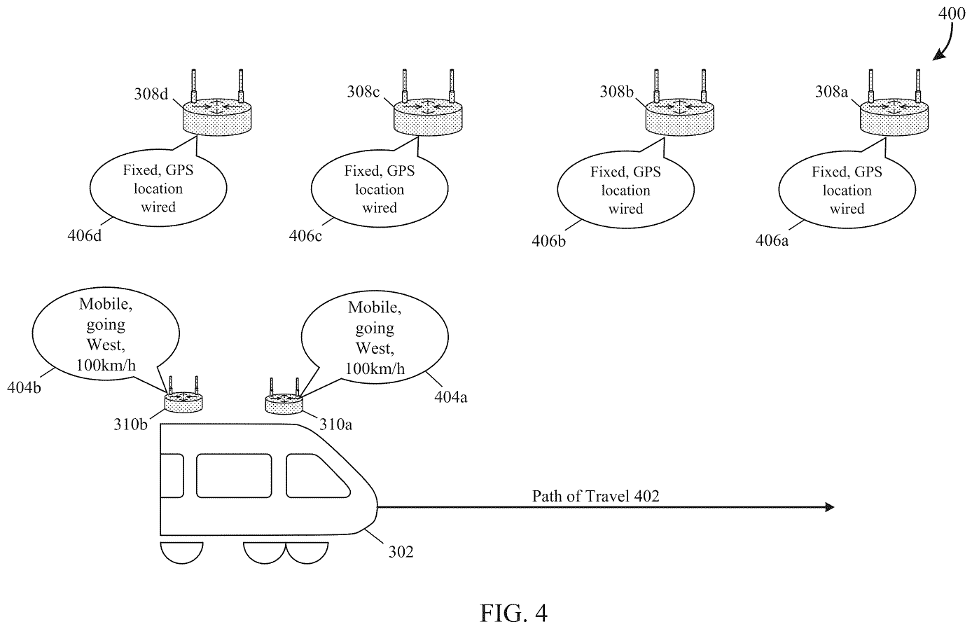

FIG. 4 illustrates an example 400 of wireless devices advertising their capabilities, according to various implementations. As shown, consider the case in which there are access points 308 such as access point 308a, access point 308b, access point 308c, and access point 308d, which have not yet formed the wireless backhaul network shown in FIG. 3. In addition, there may also be mobile nodes 310, such as mobile node 310a and mobile node 310b, that are located onboard mobile system 302 and described previously.

As noted previously, formation and configuration of a network such as the one shown in FIG. 3 is largely a manual task today, requiring each node/device in the network to be set up, prior to use. In various embodiments, the techniques herein introduce an automated approach whereby the devices first determine their own properties and capabilities. This can be done such as at the time of device startup (e.g., as part of a boot routine), on demand, or the like.

In various implementations, each of access points 308 and mobile nodes 310 may begin by assessing its wired network connectivity, if any. This determination can help during configuration of the wireless network, such as during the designation of a mesh-end, which is responsible for relaying communications from other devices in the mesh (e.g., towards or from L3-routed network 304, for instance).

A device may take any number of suitable steps to determine whether it has wired connectivity. For instance, in some cases, the device may attempt to access well-known IP addresses, such as a wireless LAN controller (WLC) in its network, Internet nodes, or the like. The device may also perform access checks, to take advantage of traceroute, to determine the network path. In further cases, the device may also based its determination on discovery protocol information such as Link Layer Discovery Protocol (LLDP) information or Cisco Discovery Protocol information.

If any or all of the above indicate that the device is on a wired network path, then the device may determine that it has a wired connection available.

In various implementations, the device may also make another determination as to whether it is a fixed/stationary device or a mobile device. As would be appreciated, mobile devices in a network such as FIG. 3 may operate quite differently than that of stationary ones. To make this determination, the device may take advantage of any inertial sensors, if available, to determine whether it moves over time. In another instance, the device may rely on coordinate information, such as Global Positioning System (GPS) location data. In yet another instance, the device may base this determination on Wi-Fi information available by communicating with nearby Wi-Fi devices. For instance, the device may rely on Wi-Fi information such as Wi-Fi Fine Timing Measurement (FTM) information, round-trip time (RTT) measurements, received signal strength indicator (RSSI) information, or the like.

Once the device has determined its capabilities from the above analyses, it may send out a wireless advertisement of its capabilities to its neighbor(s). Such an advertisement may take the form of beacon frames, probe responses, action frames, proprietary frames, Access Network Query Protocol (ANQP) messages, or any other suitable mechanism. In the advertisement, the device may share its discovered properties such as whether the device is wired, mobile vs fixed, its movement parameters such as GPS location and measurements, speed, direction (e.g., direction of travel 402), patterns, etc., device model, installed software, or the like.

In some implementations, the device may also include in its advertisement a measure as to how confident the device is about its determined capabilities. For instance, a device with very good GPS and inertial sensors may score its movement/location determination with a 99% confidence factor. Conversely, a device with poor GPS signal may only assign a 10% confidence factor to its determination.

By way of example, as shown, assume that both of mobile node 310a and mobile node 310 b determine that they are mobile and going West at a velocity of 100 km/h and that they are not connected to the wired network. Note that mobile node 310a and mobile node 310b may still have wired connections, such as being connected to a wired LAN within mobile system 302. However, without wired connectivity to a specific device, service, or the Internet, it may still determine that it does not fit the criteria as a wired device for purposes of forming the wireless network. In such a case, mobile node 310a may transmit an advertisement 404a indicative of its capabilities and mobile node 310b may likewise transmit advertisement 404b indicative of its capabilities.

Meanwhile, mobile nodes 310 shown may determine that they each are fixed nodes at specific GPS locations and have wired connectivity. In such a case, access point 308a may transmit advertisement 406a indicative of its capabilities, access point 308b may transmit advertisement 406b indicative of its capabilities, access point 308c may transmit advertisement 406c indicative of its capabilities, and access point 308d may transmit advertisement 406d indicative of its capabilities.

As would be appreciated, the indications of the capabilities of a given device may vary as desired and may be explicit or implicit. For instance, a device may only explicitly indicate whether it has wired connectivity, allowing any receivers of its advertisement to assume that it is wireless-only if this is not indicated. In another example, a device advertising its velocity or direction of travel may implicitly indicate that the device is mobile.

With the advertised properties of its neighbors, the device may also refine its own properties/capabilities, in some implementations. For instance, a device whose capabilities have a low confidence factor can identify itself as mobile if its neighbors with high confidence factor are constantly present in its scanning. A device can also perform FTM ranging in this phase to refine further. In some cases, the device may send out an updated advertisement based on the advertisement(s) that it receives from its neighbor(s).

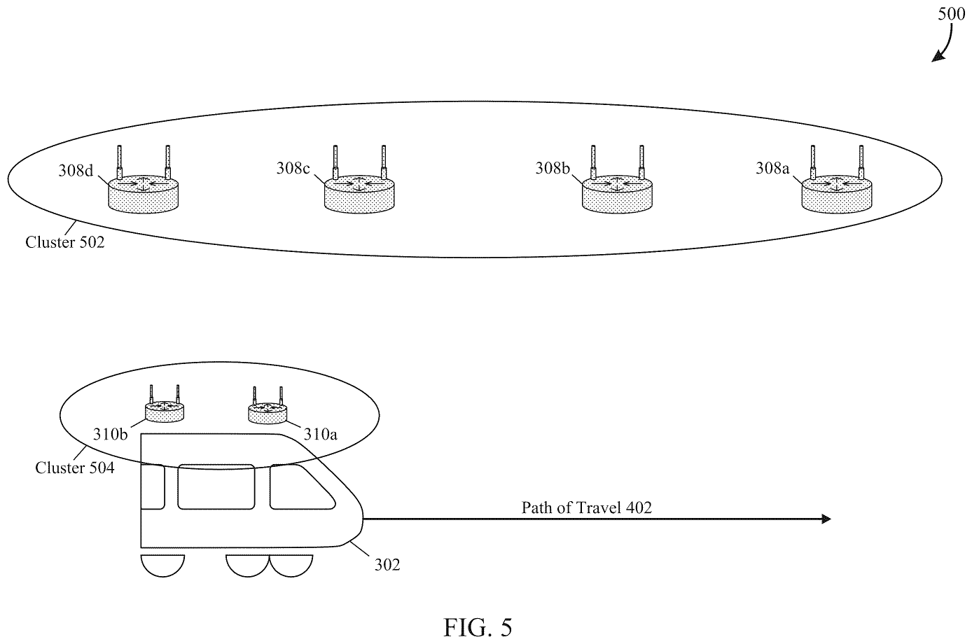

FIG. 5 illustrates an example 500 of wireless nodes forming network clusters based on their roles, according to various implementations. Continuing the example in FIG. 4, after the devices have advertised their capabilities, they may begin forming the wireless network based on their role assignments. In various implementations, these role assignments may be made centrally, such as by a network controller, supervisory service, or under the supervision of an administrator. In other cases, the devices themselves may assign their own roles to one another in a distributed manner or self-assignment. The same may be true for purpose of clustering the devices during formation of the network, as well.

In various implementations, if a device is “mobile,” it may be assigned a mobile role in the wireless network and configured as a mesh point. In turn, any mobile devices may be clustered based on factors such as any or all of the following:
whether the devices move together (e.g., as determined by their movement patterns and GPS/FTM measurements)
their location/neighbors
their device models/tags
etc.

For instance, as mobile node 310a and mobile node 310b are both located onboard mobile system 302 and traveling together, they join a mobile cluster 504. In such a case, they may be configured to cooperate for purposes of providing wireless connectivity to mobile system 302, such as by coordinating handoffs between access points during movement.

Meanwhile, if a device is fixed and it has wired connectivity, then its role may indicate it as a fixed node. In turn, multiple fixed nodes may joint the same cluster. For instance, access point 308a, access point 308b, access point 308c, and access point 308d may join cluster 502. In such fixed clusters, one of the devices may also serve as the mesh-end, relaying communications to/from the other cluster members via its wired connection.

In some instances, selection of a particular fixed node as the mesh-end of a cluster may be based on factors such as its bandwidth, channel quality information, its number of reachable neighbors, or the like. In turn, the WLC, network controller, supervisory service, or the like, may elect a node from the cluster (e.g., access point 308a in cluster 502) as the mesh-end and notify each of the members, accordingly. In another implementation, an administrator may make the selection of the mesh-end via a user interface.

Then, in one embodiment, the clusters are provided with a common site configuration that allows them to cooperate and reach the determined mesh-end. In some instances, a common network template could be used to drive this configuration. Indeed, the number of possible configurations is small and existing configurations could be used to populate a set of possible of templates. In such cases, the system could retrieve the best/most similar template whose characteristics most closely matches the current deployment.

In another embodiment, the system may present a cluster to the administrator who can determine their general templated configuration and the configuration template to apply to the cluster.

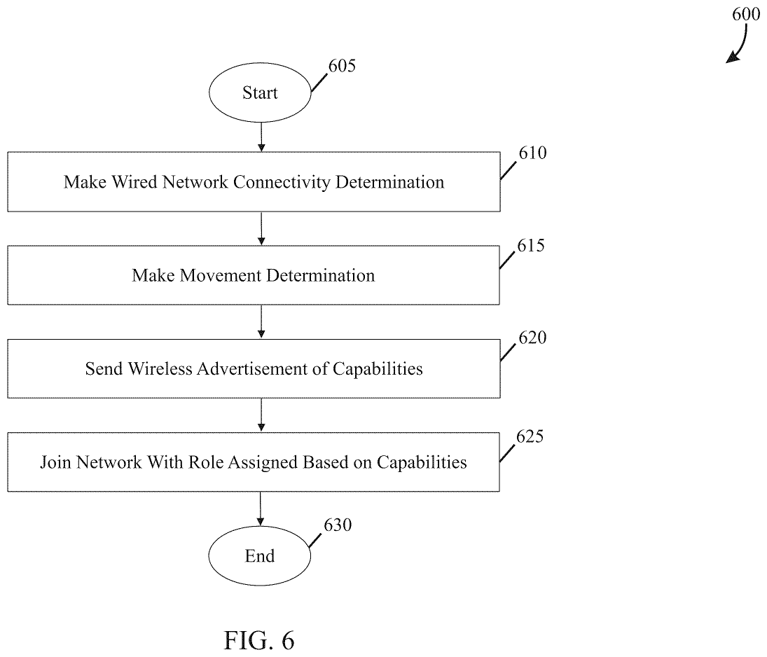

FIG. 6 illustrates an example procedure 600 (e.g., a method) for wireless node role determination based on location or movement, in accordance with one or more embodiments described herein. For example, a non-generic, specifically configured device/apparatus (e.g., device 200) may perform procedure 600 by executing stored instructions (e.g., communication process 248 and/or routing process 244). Procedure 600 may start at step 605 and continues on to step 610 where, as described in greater detail above, the device may make a first determination as to whether it has wired network connectivity. In some implementations, the device makes the first determination based in part on Link Layer Discovery Protocol (LLDP) information. In further implementations, the device makes the first determination in part by attempting to access one or more Internet Protocol addresses. In some cases, the device is onboard a vehicle or autonomous robot.

At step 615, as detailed above, the device may make a second determination as to whether it is moving over time. In some implementations, the second determination is based on Fine Timing Measurement (FTM) data. In further implementations, the second determination is based on Global Positioning System (GPS) data.

At step 620, the device may send an advertisement of capabilities of the device based on the first determination and on the second determination, as described in greater detail above. In some implementations, the advertisement includes an indication as to how confident the apparatus is about its capabilities indicated in the advertisement.

At step 625, as detailed above, the device may join a wireless network with a role assigned to the device based on the capabilities of the device indicated in the advertisement, wherein the role is either a fixed node role or a mobile node role. In some implementations, joining the wireless network may entail joining a cluster comprising at least one other device having a same role as that of the device. In some cases, he device and the at least one other device in the cluster have mobile node roles and are jointly configured via the wireless network to coordinate handoffs between access points of the wireless network. In further cases, the device and the at least one other device in the cluster have fixed node roles, and wherein the device is designated as a mesh end for the cluster based on the capabilities of the device indicated in the advertisement. In some instances, the device and the at least one other device in the cluster are jointly configured by an administrator. In various implementations, the wireless network is configured according to a template, based in part on the capabilities of the device indicated in the advertisement.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for wireless node role determination based on location or movement, it is to be understood that various other adaptations and modifications may be made within the spirit and scope of the embodiments herein. For example, while certain embodiments are described herein with respect to using certain wired and/or wireless protocols, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
making, by a device, a first determination as to whether it has wired network connectivity;
making, by the device, a second determination as to whether it is moving over time;
sending, by the device, an advertisement of capabilities of the device based on the first determination and on the second determination; and
joining, by the device, a wireless network with a role assigned to the device based on the capabilities of the device indicated in the advertisement, wherein the role is either a fixed node role or a mobile node role.

2. The method as in claim 1, wherein the device makes the first determination based in part on Link Layer Discovery Protocol (LLDP) information.

3. The method as in claim 1, wherein the device makes the first determination in part by attempting to access one or more Internet Protocol addresses.

4. The method as in claim 1, wherein the second determination is based on Fine Timing Measurement (FTM) data.

5. The method as in claim 1, wherein joining the wireless network comprises:
joining a cluster comprising at least one other device having a same role as that of the device.

6. The method as in claim 5, wherein the device and the at least one other device in the cluster have mobile node roles and are jointly configured via the wireless network to coordinate handoffs between access points of the wireless network.

7. The method as in claim 5, wherein the device and the at least one other device in the cluster have fixed node roles, and wherein the device is designated as a mesh end for the cluster based on the capabilities of the device indicated in the advertisement.

8. The method as in claim 5, wherein the device and the at least one other device in the cluster are jointly configured by an administrator.

9. The method as in claim 1, wherein the wireless network is configured according to a template, based in part on the capabilities of the device indicated in the advertisement.

10. The method as in claim 1, wherein the device is onboard a vehicle or autonomous robot.

11. An apparatus, comprising:
one or more network interfaces to communicate in a backhaul mesh for a wireless network;
a processor coupled to the one or more network interfaces and configured to execute one or more processes; and
a memory configured to store a process that is executable by the processor, the process when executed configured to:
make a first determination as to whether the apparatus has wired network connectivity;
make a second determination as to whether the apparatus is moving over time;
send an advertisement of capabilities of the apparatus based on the first determination and on the second determination; and
join a wireless network with a role assigned to the apparatus based on the capabilities of the apparatus indicated in the advertisement, wherein the role is either a fixed node role or a mobile node role.

12. The apparatus as in claim 11, wherein the apparatus makes the first determination based in part on Link Layer Discovery Protocol (LLDP) information.

13. The apparatus as in claim 11, wherein the apparatus makes the first determination in part by attempting to access one or more Internet Protocol addresses.

14. The apparatus as in claim 11, wherein the second determination is based on Fine Timing Measurement (FTM) data.

15. The apparatus as in claim 11, wherein the apparatus joins the wireless network by:
joining a cluster comprising at least one other device having a same role as that of the apparatus.

16. The apparatus as in claim 15, wherein the apparatus and the at least one other device in the cluster have mobile node roles and are jointly configured via the wireless network to coordinate handoffs between access points of the wireless network.

17. The apparatus as in claim 15, wherein the apparatus and the at least one other device in the cluster have fixed node roles, and wherein the apparatus is designated as a mesh end for the cluster based on the capabilities of the apparatus indicated in the advertisement.

18. The apparatus as in claim 15, wherein the apparatus and the at least one other device in the cluster are jointly configured by an administrator.

19. The apparatus as in claim 11, wherein the advertisement includes an indication as to how confident the apparatus is about its capabilities indicated in the advertisement.

20. A tangible, non-transitory, computer-readable medium storing program instructions that cause a device to execute a process comprising:
making, by the device, a first determination as to whether it has wired network connectivity;
making, by the device, a second determination as to whether it is moving over time;
sending, by the device, an advertisement of capabilities of the device based on the first determination and on the second determination; and
joining, by the device, a wireless network with a role assigned to the device based on the capabilities of the device indicated in the advertisement, wherein the role is either a fixed node role or a mobile node role.
